(19) United States
(12) Patent Application Publication
(10) Pub. No.: US 2003/0123644 A1
(43) Pub. Date: Jul. 3, 2003

(54) Method and apparatus for removing audio artifacts

(76) Inventors: Scott E. Harrow, Scottsdale, AZ (US); Samuel L. Thomasson, Gilbert, AZ (US)

Correspondence Address: Paul F Wille, 6407 E Clinton Street, Scottsdale, AZ, 85254, US

(21) Appl. No.: 09/491,360

(22) Filed: Jan. 26, 2000

(51) Int. Cl. H04M 9/00; H04M 1/00

(52) U.S. Cl. 379/387.01

(57) ABSTRACT

A telephone having a line input, a line output, a handset microphone, and a handset speaker also includes a first soft mute circuit coupling the handset microphone and the line output and a second soft mute circuit coupling the line input and the handset speaker. The telephone is operated in a first mode and can change modes only after muting one or both soft mute circuits, changing mode, and then operating in the second mode only after unmuting the circuits. The muting may be momentary or prolonged, depending upon the particular mode of operation. An additional soft mute circuit is used in a speakerphone.

### CROSS-REFERENCE TO RELATED APPLICATIONS

This application includes material disclosed in the following applications assigned to the assignee of this invention. The entire contents of each of these earlier applications are incorporated herein by reference.

(1) application Ser. No. 09/360,211, filed Jul. 23, 1999, entitled “Acoustic and Electronic Echo Cancellation”, now U.S. Pat. No. ______.

(2) application Ser. No. 09/413,675, filed Oct. 6, 1999, entitled “Tagging Echoes with Low Frequency Noise”, now U.S. Pat. No. ______.

(3) application Ser. No. 09/435,374, filed Nov. 5, 1999, entitled “Background Communication using Shadow of Audio Signal”, now U.S. Pat. No. ______.

(4) application Ser. No. 09/476,468, filed Dec. 30, 1999, entitled “Band-by-Band Full Duplex Communication”, now U.S. Pat. No. ______.

(5) application Ser. No. 09/______, filed Jan. 13, 2000, entitled “Soft Mute Circuit”, now U.S. Pat. No. ______.

### BACKGROUND

This invention relates to a method for controlling the operation of a telephone and, in particular, to a method for operating a telephone to remove unwanted audio artifacts.

Advances in programmable digital logic and fixed digital logic has enabled function upon function to be added to a product, as apparent for example from the number of services presently offered in addition to basic telephone service. Within a telephone, particularly a cellular telephone, a plurality of functions are carried out that are transparent to a user, i.e. the user is unaware of the functions taking place.

A problem with the desire and ability to add functions without limit is the possibility that the functions will interact, causing unexpected results. Another problem, of particular concern in a telephone, is the desire to eliminate noise. There are several kinds of noise, one of which is an echo, either acoustic or electrical. Another kind of noise is a transient signal produced by switching electrical signals with a telephone.

Many techniques have been developed to improve the clarity of the sound in a telephone. One such technique uses what is known as a comb filter; i.e. a plurality of filters wherein band pass filters alternate with band stop filters. Comb filters with complementary pass and stop bands are coupled in the two audio channels connecting the two stations of a telephone call. That is, the pass bands in one channel are the stop bands in the other channel. As a result, a signal traveling in one direction will be slightly attenuated but a signal traveling in a loop, i.e. an echo, will encounter both sets of stop bands and be highly attenuated. Another attempt at reducing noise requires selecting a subset of band pass filters from a larger set.

Switching filters, putting a caller on hold, activating a second line, switching between speaker phone and a hand set, and other such functions all generate transient signals. Above-identified, co-pending application (5) discloses a circuit for eliminating transient signals by muting an output before switching filters and unmuting the output after the filters are selected. It is desired to provide even more functions and yet be unobtrusive in operation.

It is known in the art to mute a power amplifier when the amplifier is turned on. U.S. Pat. No. 4,983,927 (Torazzina) discloses a bias circuit that causes a power amplifier to go through “mute” and “standby” states when the amplifier changes from normal operation to “cut-off” for blocking transients.

In view of the foregoing, it is therefore an object of the invention to provide a method for removing all audio artifacts from a telephone.

Another object of the invention is to provide a telephone that changes state with no perceptible loss of audio information.

A further object of the invention is to provide an operating system that adapts a telephone to a variety of possible operating conditions without intervention by a user.

Another object of the invention is to provide a state machine for a telephone that is transparent to a user.

### SUMMARY OF THE INVENTION

The foregoing objects are achieved in this invention in which a telephone having a line input, a line output, a handset microphone, and a handset speaker also includes a first soft mute circuit coupling the handset microphone and the line output and a second soft mute circuit coupling the line input and the handset speaker. The telephone is operated in a first mode and can change modes only after muting one or both soft mute circuits, changing mode, and then operating in the second mode only after unmuting the circuits. The muting may be momentary or prolonged, depending upon the particular mode of operation. An additional soft mute circuit is used in a speakerphone.

### BRIEF DESCRIPTION OF THE DRAWINGS

A more complete understanding of the invention can be obtained by considering the following detailed description in conjunction with the accompanying drawings, in which:

FIG. 1 is a block diagram of a pair of telephones having complementary comb filters as known in the prior art;

FIG. 2 is a chart illustrating the frequency responses of the filters in FIG. 1;

FIG. 3 is a block diagram of the microphone to line output channel in a telephone constructed in accordance with one aspect of the invention;

FIG. 4 is a block diagram of the line to speaker channel in a telephone constructed in accordance with one aspect of the invention;

FIG. 5 is a block diagram of a soft mute circuit constructed in accordance with another aspect of the invention;

FIG. 6 is a chart illustrating the operation of the circuit in FIG. 5;

FIG. 7 is a block diagram of a plurality of soft mute circuits in a telephone constructed in accordance with another aspect of the invention;

FIG. 8 is a flow chart illustrating the operating system of the invention;

FIG. 9 illustrates a power-on state machine constructed in accordance with the invention;

FIG. 10 illustrates a mute sequence state machine constructed in accordance with the invention

FIG. 11 illustrates a multiplex sequence state machine constructed in accordance with the invention;

FIG. 12 illustrates an A/B shadow state machine.

### DETAILED DESCRIPTION OF THE INVENTION

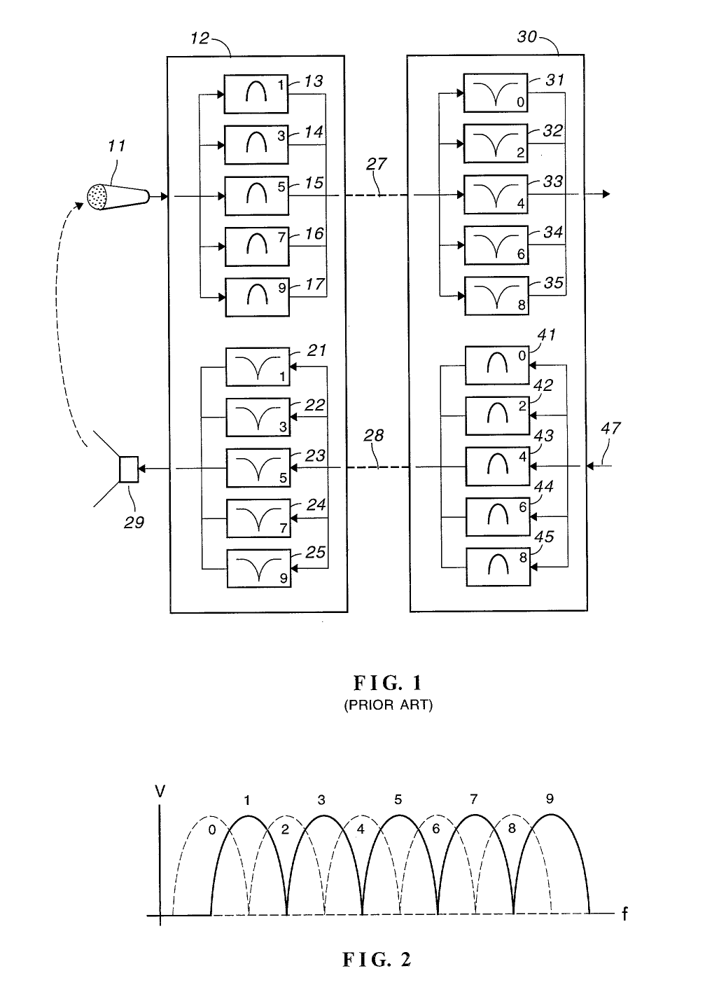

FIG. 1 illustrates the operation of complementary comb filters. In FIG. 1, sound incident upon microphone 11 is converted into an electrical signal and coupled to telephone 12. A portion of the circuitry within telephone 12 includes band pass filters 13, 14, 15, 16, and 17. For a bandwidth of 300-3,400 Hz, five filters are typical. More than five filters may result in too much overlap between bands.

Telephone 12 also includes notch filters 21, 22, 23, 24, and 25. The center frequencies of the notch filters correspond to the center frequencies of the band pass filters. Thus, a signal passing through the band pass filters, traveling along transmission line 27 and reflected back to transmission line 28 would be attenuated by the notch filters. A single telephone constructed in this fashion provides approximately 10 dB of attenuation of a signal between microphone 11 and speaker 29 for electronic echoes.

Telephone 30 is constructed in like manner except that the center frequencies of the filters are offset from the center frequencies of the filters in telephone 12. Specifically, the center frequencies of notch filters 31, 32, 33, 34, and 35 are between the center frequencies of the band pass filters in telephone 12. Thus, the notch filters in telephone 30 are aligned with the dead bands between the band pass filters in telephone 12, which further increases the effectiveness of the circuit.

Telephone 30 also includes band pass filters 41, 42, 43, 44, and 45 having the same center frequencies as the notch filters in telephone 30. Thus, a signal on input 47, e.g., from a microphone (not shown), is divided among the band pass filters, summed, and transmitted over line 28 to telephone 12. The center frequencies of the notch filters in telephone 12 correspond to the dead bands between the bands of band pass filters 41-45, enhancing the operation of these filters.

The operation of telephones 12 and 30 is illustrated in FIG. 2. The center frequencies are numbered consistently with FIG. 1. There are two sets of filters for two telephones, which means that one must have an “A” telephone and a “B” telephone in order to obtain complementary filter characteristics. In accordance with one aspect of the invention, this problem is overcome by having a plurality of band pass filters in each channel and control circuitry for assigning the filters to each channel. The filters are assigned in such a way as to maintain full duplex operation if at all possible.

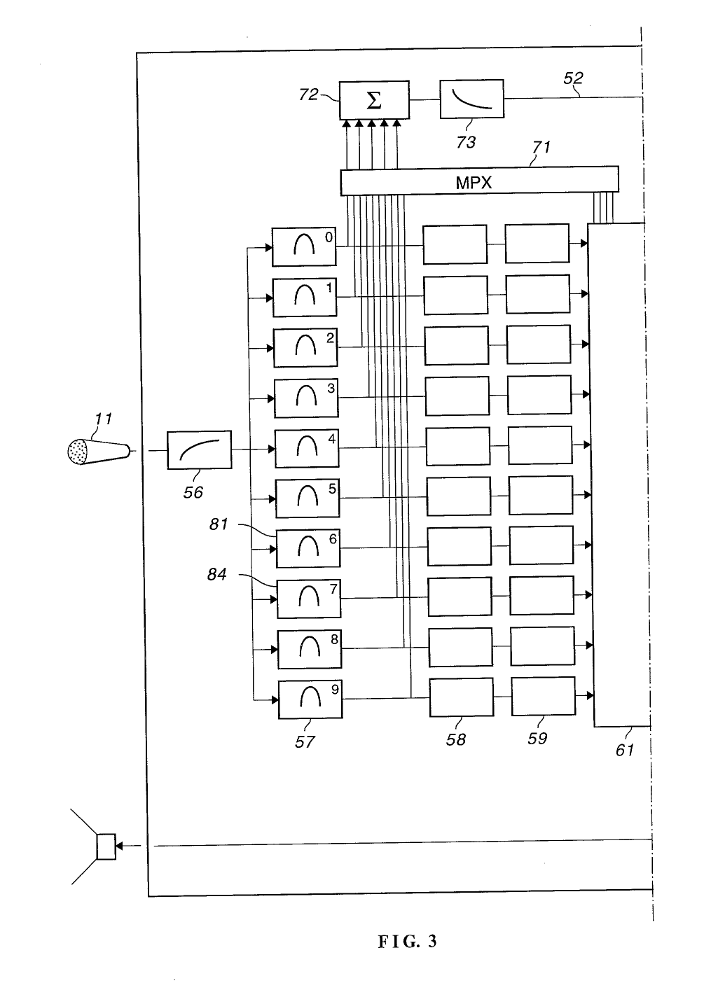

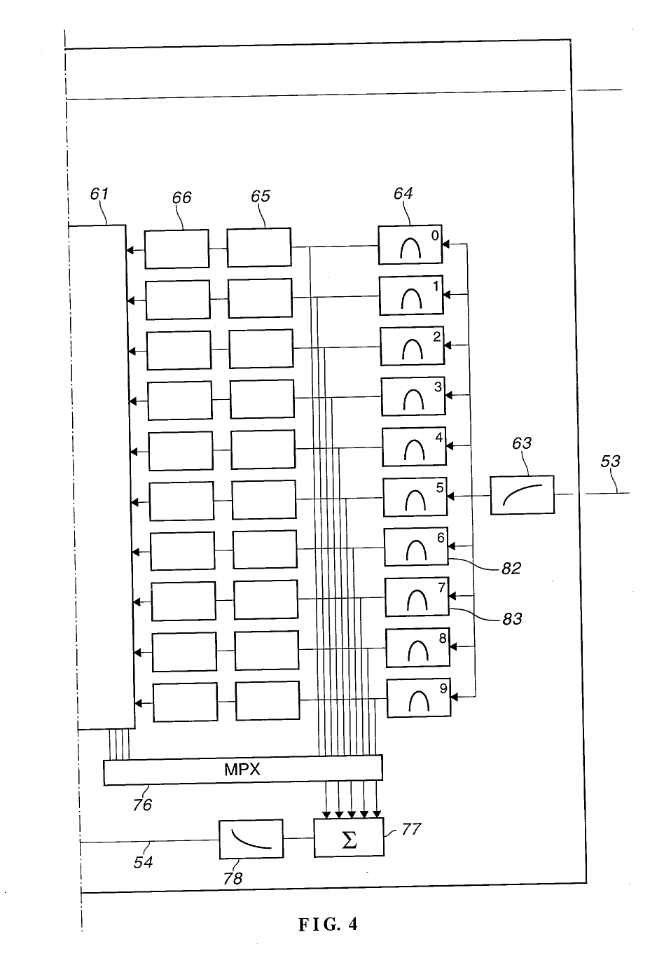

FIGS. 3 and 4 together illustrate a telephone in which filters are allocated between two channels in accordance with any one of several priorities. FIG. 3 is a block diagram of a first channel, extending from microphone 51 to line output 52, and FIG. 4 is a block diagram of a second channel, extending from line input 53 to speaker output 54. A handset (not shown) may be included in the telephone and coupled to the lines by appropriate switching circuitry.

Sound incident upon microphone 11 (FIG. 3) is converted into an electrical signal and coupled to weighting filter 56. Weighting filter 56 reduces the amplitude of low frequency signals to provide a more even energy distribution among the bands. Filter 56 can also be used to correct for non-linearities in the frequency response of microphone 51. The output from filter 56 is coupled to a first plurality of band pass filters, e.g. one-third octave filters. Much of the apparatus is duplicative and only one band is described.

Band pass filter 57 is coupled to filter 56 and to amplitude detector 58, which, for example, includes a rectifier and a low pass filter. More complex amplitude detectors can be used instead. The output from amplitude detector 58 is coupled to sample and hold circuit 59, which provides a stable signal for controller 61.

Weighting filter 63 (FIG. 4) receives signals from line input 53 and is coupled to a second plurality of band pass filters. Band pass filter 64 is coupled to filter 63 and to amplitude detector 65. The output from amplitude detector 65 is coupled to sample and hold circuit 66. Controller 61 receives the signals from all the sample and hold circuits and contains the logic for comparing the amplitudes of the signals in each band in each channel. The logic can be fixed or programmable.

In FIG. 3, controller 61 is coupled to the control inputs to multiplex circuit 71. Each band pass filter, such as filter 57, has an output coupled to a signal input of multiplex circuit 71, which has a plurality of signal output lines coupled to summation circuit 72. The output of summation circuit 72 is coupled to de-weighting filter 73, which as the inverse frequency response of filter 56. The output of de-weighting filter 73 is coupled to line output 52.

In FIG. 4, controller 61 is coupled to the control inputs to multiplex circuit 76. Each band pass filter, such as filter 64, has an output coupled to a signal input of multiplex circuit 76, which has a plurality of signal output lines coupled to summation circuit 77. The output of summation circuit 77 is coupled to de-weighting filter 78, which as the inverse frequency response of filter 63. The output of de-weighting filter 63 is coupled to speaker output 54.

With all the data flowing into controller 61, the filters can be allocated several different ways. For example, the loudest signal from any filter is found and that filter and the alternate filters in the same bank are allocated to a line. The filters in the second bank that correspond to the remaining filters in the first bank are assigned to the other line.

For example, filter 81 (FIG. 3) and filter 82 (FIG. 4) have substantially the same center frequency. If filter 81 produces the loudest signal of all, then the output from filter 81 is coupled to summation circuit 72 by multiplex circuit 71. Filter 82 is cut off from summation network 77 by multiplex circuit 76, while filter 83 is coupled to the summation network. Alternate filters in each bank are enabled, allocating the ten bands between the two channels.

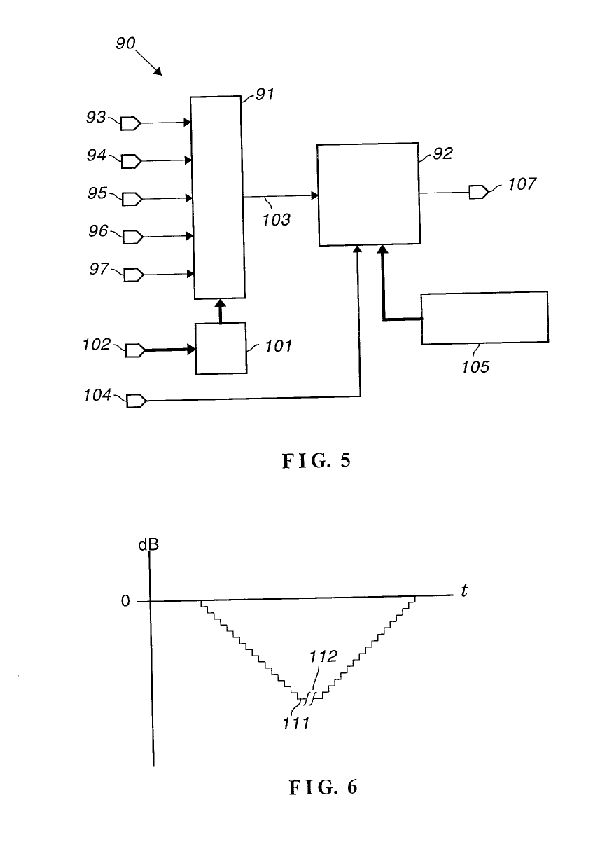

FIG. 5 is a schematic of a circuit that is preferably substituted for a multiplex circuit and a summation circuit, as used in FIGS. 3 and 4. In FIG. 5, soft mute circuit 90 includes summation circuit 91 and variable gain circuit 92. Inputs 93, 94, 95, 96, and 97 are from separate signal sources [not shown] and are selected in accordance with data on input 102 by way of decoder 101. In the figures, plural lines are represented by a single heavy line rather than a plurality of thin lines. Input 102 is actually five inputs, one enable line for each signal line. An advantage of having a summation circuit shown is that the signal lines can be summed in any combination on output line 103.

Circuit 92 includes a variable gain amplifier that adjusts the amplitude of the signal on line 103 and couples the adjusted signal to circuit output 107. Circuit 92 is controlled by enable input 104 and register 105. In one embodiment of the invention, register 105 was eight bits wide. The data in the register determines the maximum amplitude of the signal on output 107.

The operation of soft mute circuit 90 is illustrated in FIG. 6. Assuming unity (zero dB) gain as an initial condition, a logic “1” on enable input 104 causes the gain of circuit 92 to decrease incrementally for as long as pin 104 remains at a logic “1” or until a minimum gain is reached, preferably −40 dB or more.

The gain remains at minimum 111 (FIG. 6) so long as a logic “1” is applied to input 104. Gap 112 represents the mute period. When a logic “0” is applied to input 114, the gain of the circuit increases to a value corresponding the data in register 105. By reducing the gain to a minimum prior to a transient, the transient is not coupled to output 107. Thus, the circuit illustrated in FIG. 5 is used in several places in a telephone constructed in accordance with the invention.

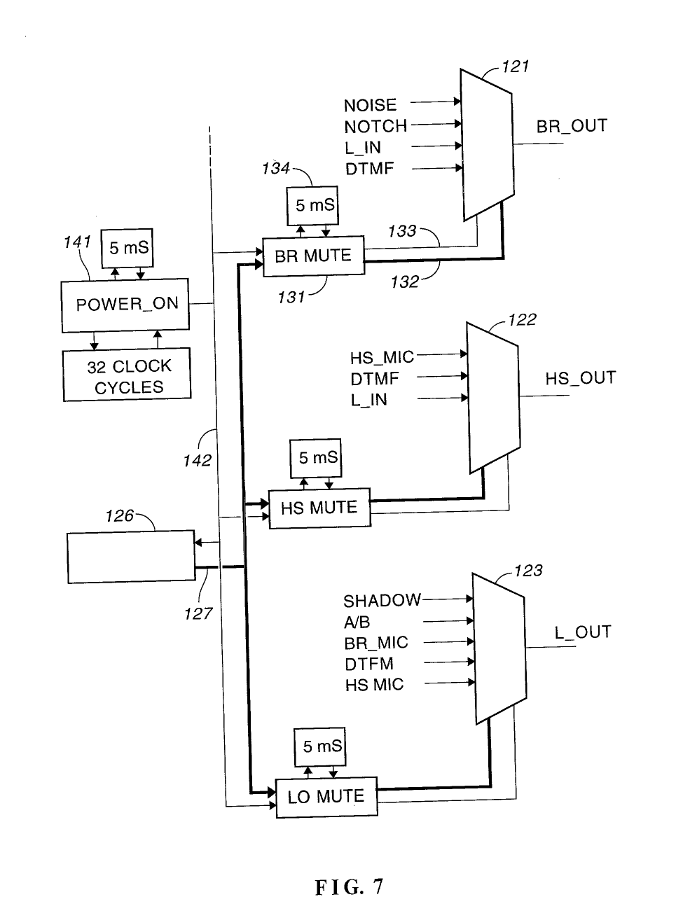

FIG. 7 is a block diagram of a portion of a telephone constructed in accordance with one aspect of the invention. Blocks 121, 122, and 123 are “soft mute” circuits constructed as illustrated in FIG. 5. The output from mute circuit 121, labeled “BR₁₃OUT”, is coupled to the speaker in a base receiver or speaker phone. The output from mute circuit 122, labeled “HS₁₃OUT”, is coupled to the speaker in the earpiece of a handset. The output from mute circuit 123, labeled “L₁₃OUT”, is coupled to the line output of the telephone.

Some inputs are common to all three mute circuits, e.g. the “DTMF” tones being dialed. The “NOISE” input to mute circuit 121 receives a noise marker signal as described in related application (1), identified above. The “NOTCH” input is coupled to the noise reduction filters described above. The “L₁₃IN” input is coupled to the input line to the telephone, connecting the telephone to a network.

Mute circuit 122 has three inputs. The “DTMF” and “L₁₃IN” inputs are in common with mute circuit 121. The “HS₁₃MIC” input is in common with mute circuit 123 and is coupled to the microphone in the handset (not shown).

The “SHADOW” input to mute circuit 123 receives a shadow signal as described in related application (2), identified above. (A shadow signal is an audio signal delayed less than fifty milliseconds). Mute circuit 123 combines the delayed signal with an undelayed signal on input “BR₁₃MIC” or input “HS₁₃MIC”. Input “BR₁₃MIC” is coupled to the microphone in the base receiver. Input “A/B” is coupled to the output of another soft mute circuit that activates filters in group “A” or in group “B”, depending upon whether or not a shadow signal is detected; see related application (3) identified above. (In order to have complementary comb filters, an “A” telephone must communicate with a “B” telephone.)

Multiplex circuit 126 provides selection data on bus 127. Each mute control circuit decodes the data to provide mute enable and selection signals to the respective mute circuits. Taking mute circuit 121 as an example, control circuit 131 receives data from multiplex circuit 126 on bus 127. The data is decoded into selection data on bus 132 (corresponding to input 102 in FIG. 5). When enable line 133 goes high, the gain of mute circuit 121 decreases from a given value, determined by the data in the register, and then ramps up to the same value when the enable line goes low. Timer 134 times out a predetermined period while the mute takes place, preventing control circuit 131 from changing state during a transition in circuit 121.

All circuits await an enable signal from power-on circuit 141 before becoming active. When power is applied to the telephone, circuit 141 starts its own clock and waits a given number of clock cycles for other clocks (not shown) in the telephone to stabilize. Other clocks, for example, include 44.1 dual phase clocks used for sampling and switched capacitor circuits (not shown) such as used for filters and time delay circuits. In one embodiment of the invention, circuit 141 waits thirty-two of its clock cycles, then waits five milliseconds for all analog circuits to turn on and stabilize. After the five millisecond period, a logic “1” is applied to power-on enable line 142.

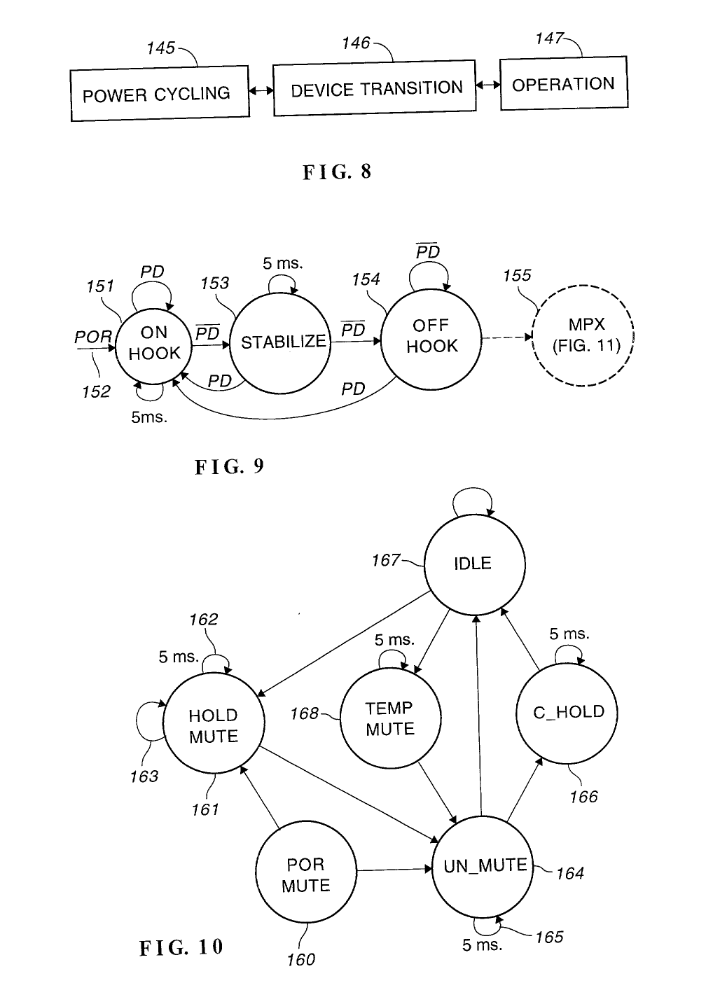

The start-up procedure and operation of multiplex circuit 126 are more easily understood from state diagrams. A state machine is any circuit containing fixed or programmable sequential logic. In a given telephone, particularly a speaker phone, there may be several state machines that interact to provide the various functions of the telephone. FIG. 8 is a block diagram of three modes of operation for a telephone. The power-on portion of the power cycle is described above. During this phase, all outputs are muted. Similarly, during power-down, all outputs are muted prior to power being shut off.

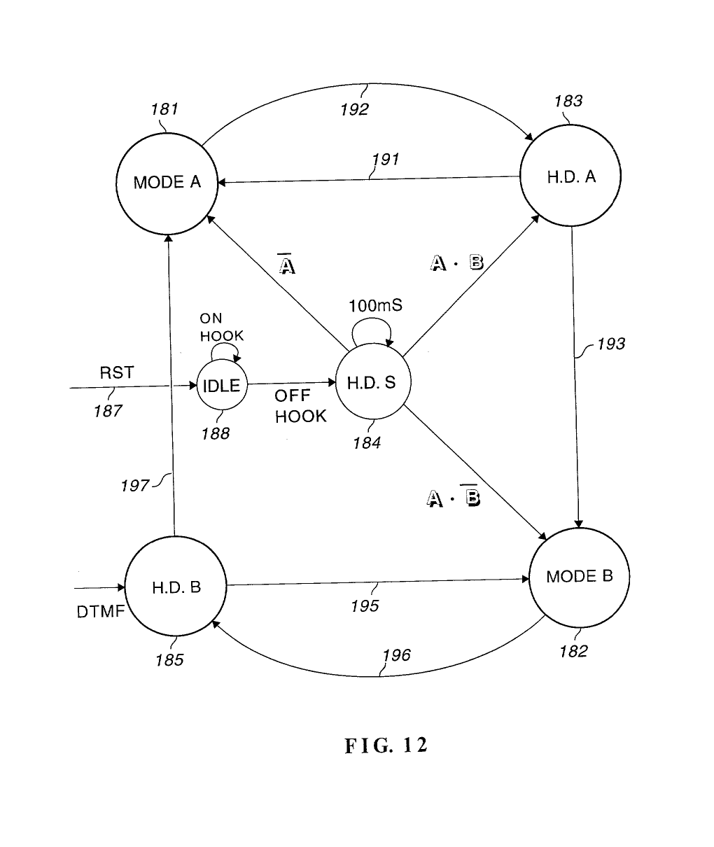

Mode 146, device transition, covers any change in the operation of the telephone. Mode 147 is the steady state operation of the telephone during a call, in either half-duplex or full duplex mode. To change mode, the telephone reverts to device transition mode 146 and enters the appropriate state, as more fully described in connection with FIGS. 11 and 12.

FIG. 9 illustrates the operation of the power-on state machine. In FIG. 9, one enters On-Hook state 151 from power-on reset 152. Suitable generators of a power-on reset signal are well known per se in the art. On-Hook state 151 is entered regardless of the physical location of the handset; i.e. whether or not the handset is in its cradle. The telephone then enters stabilizing state 152 for five milliseconds, as described above, then enters Off Hook state 154. At this point the start-up cycle is completed. Once completed, a signal on line 142 (FIG. 7) causes the power-on state machine to relinquish control to multiplex sequence state machine 155, illustrated in FIG. 11. A power-down signal causes the power on state machine to enter the On-Hook state and remain there as long as the power-down signal exists.

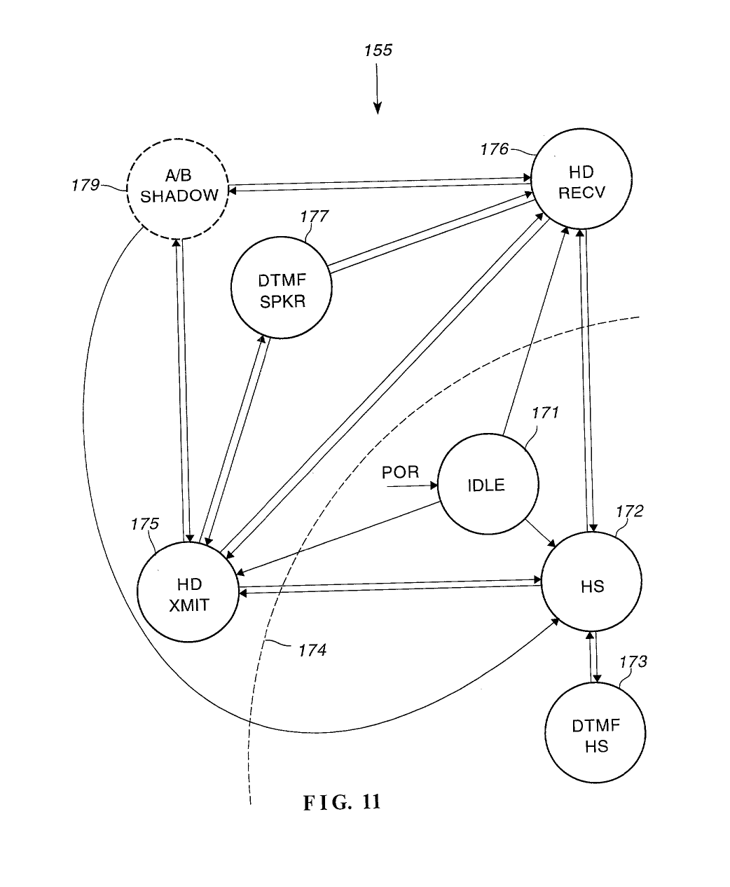

FIG. 10 illustrates the mute sequence state machine. A power-on reset signal causes all the mute circuits to enter a muted state. The state machine enters temporary state 160 and remains there until receiving a signal (POSM₁₃Done) that the power-on state machine is done, i.e. the enable signal on line 142 (FIG. 7). In state 160, all muted circuits are muted, which assures that the initial operation of the telephone does not cause any sounds in the speaker or handset.

Actually, POSM₁₃Done and one other signal are necessary to exit state 160. The other signal is either a mute command or an unmute command. Assuming the POSM₁₃Done signal and mute command are given, the machine enters hold mute state 161. As indicated by loop 162, the machine must stay in state 161 for at least five milliseconds after the state is first entered. As indicated by loop 163, state 161 is re-entrant, i.e. a stable state. After five milliseconds, only an unmute command can cause the machine to exit state 161.

From state 160, an unmute command, and the POSM₁₃Done signal, causes the machine to enter unmute state 164. As indicated by loop 165, the machine must stay in state 164 for at least five milliseconds after the state is first entered. After five milliseconds, the machine will exit state 164 and enter either state 166 or state 167, depending upon whether or not the speaker phone is being used. If not, idle state 167 is entered directly. If so, C₁₃Hold state 166 is entered for five milliseconds, then exited for idle state 167.

The C₁₃Hold state relates to copending application (1) identified above, in which a coarse delay and a fine delay are used in a circuit for eliminating echo. The five millisecond delay in state 166 gives the echo cancelling circuitry time to lock onto the echo and stabilize. Acoustic echoes are not relevant if the handset is being used. Thus, state 166 is entered only if the speakerphone is being used.

There are two paths out of idle state 167, depending upon whether the command is mute or unmute. If there is a mute command, the machine goes directly to state 161. If there is an unmute command, the machine goes to temporary mute state 168, which mutes the line output for five milliseconds. The mute before unmute assures that one enters the unmute state with the line output muted for a quiet transition.

To summarize, three sequences are supported by the mute sequence state machine: (1) mute→unmute→idle, (2) idle→mute→unmute→idle, and (3) idle→mute. One or another of these sequences are applied to the three outputs (FIG. 7) by the multiplex sequence state machine.

FIG. 11 is the state diagram for the multiplex sequence state machine. From power on reset, the machine enters idle state 171. Note that all states in the multiplex sequence state machine are stable; i.e. the correct command must be received to exit along a particular path. All exits from state 171 require a \overline{PD} signal, i.e. the absence of a power down signal, and at least one additional signal. If there is also a handset enable signal, then the machine exits to state 172. In the process, the speaker output (of the base receiver) is muted, the handset is unmuted (sequence 1), and the line output is unmuted (sequence 1).

If a call is being made, a DTMF enable signal causes the machine to enter state 173 for the duration of the dialing, ending with a DTMF disable signal. The tones are audible in the handset and are sent to the line output but are not coupled to the speakerphone.

The states within arc 174 operate in full duplex mode and acoustic echo cancellation measures are unnecessary and not enabled. Outside of arc 174, the system is operating as a speakerphone and noise reduction circuitry and echo cancelling circuitry, as described in the above-identified applications, is enabled and disabled silently in accordance with the invention.

From idle state 171, if a handset disable signal and a receive disable signal are also received (with the \overline{PD} signal), then the machine enters half-duplex transmit state 175, in which the handset is muted, the speakerphone is unmuted and the line output is unmuted. From idle state 171, if a handset disable signal and a receive enable signal are also received, then the machine enters half-duplex receive state 176, in which the handset is muted, the speakerphone receiver line is unmuted and the line output is muted. In states 175 or 176, a receive enable or a receive disable signal will switch the machine between the two states, with the corresponding adjustment of outputs. While in either state 175 or 176, a handset enable signal with cause the machine to switch to state 172. From state 172, a handset disable signal and a receive disable will return the machine to state 175. A handset disable signal and a receive enable will return the machine to state 176.

State 177 is entered from either state 175 or 176 in response to a DTMF enable signal. State 177 is exited when a DTMF disable signal and either a receive enable signal is received (for state 176) or a receive disable signal is received (for state 175).

From either state 175 or 176, a half duplex disable signal will cause the machine to enter state 179, in which the speakerphone is unmuted, the handset is muted, and the line output is unmuted. The operation of the A/B shadow state machine is illustrated in greater detail in FIG. 12. State 179 is exited to state 172 by a handset enable signal. State 179 is exited to state 175 by a half-duplex enable signal and a receive disable signal. State 179 is exited to state 176 by a half-duplex enable signal and a receive enable signal.

FIG. 12 is a diagram illustrating the A/B shadow state machine Mode A (full duplex), state 121, and mode B (full duplex), state 122, relate to the complementary subsets of filters. There are also three half duplex states, states 123, 124, and 125. A half duplex mode becomes necessary when a telephone constructed in accordance with the invention is used for conference calls of three or more parties.

State 184 is temporary and a half duplex mode. State 184 is entered by receiving a machine call. After a reset, represented by line 187, or the application of power, the machine enters an idle state in which essentially all systems are off. Upon receipt of a call, the machine goes off hook and enters state 184. In state 184, the machine is in half duplex mode while it looks for shadow signals indicating that there are other machines in either A mode or B mode. If no A shadow is found, the machine enters state 181. If the machine finds an A shadow signal but no B shadow signal, state 182 is entered. If an A shadow signal and a B shadow signal are found, then the machine enters state 183.

State 185 is typically entered by placing a call. Unlike state 184, state 185 is not necessarily temporary although the most likely outcome is that state 182 will be entered shortly after completing a connection to another party. Path 195 corresponds to path 191, path 196 corresponds to path 192, and path 197 corresponds to path 193. Entering either half duplex state returns control to the multiplex sequence state machine, either at state 175 (FIG. 11) if a receive enable command is received or state 176 (FIG. 11) if a receive disable command is received.

The invention thus provides a method for removing all audio artifacts from a telephone with no perceptible loss of audio information. The telephone adapts silently to a variety of possible operating conditions, without intervention by a user, in manner that is transparent to the user.

Having thus described the invention, it will be apparent to those of skill in the art that various modifications can be made within the scope of the invention. For example, while described as three state machines, such construction is arbitrary. One could consider an entire telephone as a single state machine. In mechanical terms, the invention can be implemented with a single programmable logic device such as a microprocessor or with a plurality of programmable or fixed logic devices. The invention can be used with any audio system, e.g. public address systems, intercoms, high fidelity systems, not just with telephones.

What is claimed as the invention is:

1. A method for removing unwanted audio artifacts in a audio device, said method comprising the steps of:
operating the device in a first mode;
changing mode only after muting the device; and
operating the device in a second mode only after unmuting the device.

2. The method as set forth in claim 1 wherein the device includes a plurality of outputs, said muting step includes the steps of muting all the outputs, and the unmuting step includes the step of selectively unmuting less than all the outputs.

3. The method as set forth in claim 2 wherein said muting step includes the step of increasingly attenuating an output until a maximum level of attenuation is reached.

4. The method as set forth in claim 1 wherein said device includes an idle state and a mute state as stable states and an unmute state as a temporary state and wherein said device can proceed from idle to mute to unmute to idle but not the reverse.

5. The method as set forth in claim 4 wherein said device includes a temporary mute state and wherein the device can proceed from idle to temporary mute to unmute to idle but not the reverse.

6. In a telephone having a line input, a line output, a handset microphone, and a handset speaker, the improvement comprising:
a first soft mute circuit coupled to said handset microphone and said line output for attenuating audio artifacts;
a second soft mute circuit coupled to said line input and said handset speaker for attenuating audio artifacts.

7. The telephone as set forth in claim 6 wherein said first soft mute circuit and said second soft mute circuit each include:
an amplifier having a gain control input for receiving digital data and a signal input;
a register having an output coupled to said gain control input;
an adder coupled to said register for storing data in said register and having a pair of inputs, said adder having a control input for adding or subtracting data on the inputs of the adder;
wherein said adder adjusts the gain of said amplifier in accordance with the signal on said control input.

8. In a speakerphone having a line input, a line output, a microphone, and a speaker, the improvement comprising:
a first soft mute circuit coupled to said microphone and said line output for attenuating audio artifacts;
a second soft mute circuit coupled to said line input and to said speaker for attenuating audio artifacts.

9. The speakerphone as set forth in claim 8 and further including a handset microphone, a handset speaker, and a third soft mute circuit coupled to said handset microphone and said handset speaker.

10. The speakerphone as set forth in claim 9 wherein said handset microphone is also coupled to said first soft mute circuit.

11. The speakerphone as set forth in claim 9 wherein said first soft mute circuit, said second soft mute circuit, and said third soft mute circuit each include:
an amplifier having a gain control input for receiving digital data and a signal input;
a register having an output coupled to said gain control input;
an adder coupled to said register for storing data in said register and having a pair of inputs, said adder having a control input for adding or subtracting data on the inputs of the adder;
wherein said adder adjusts the gain of said amplifier in accordance with the signal on said control input.
